(19) United States
(12) Patent Application Publication
(10) Pub. No.: US 2002/0186316 A1
(43) Pub. Date: Dec. 12, 2002

(54) Support sensor

(76) Inventor: John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 09/878,567

(22) Filed: Jun. 11, 2001

(51) Int. Cl. H04N 5/225

(52) U.S. Cl. 348/373

(57) ABSTRACT

A support socket is built incorporating a sensor capable of detecting when the support socket is being used. When the sensor detects the use of a support utilizing the support socket, the imaging device is notified of the support allowing the device to change its mode of operation accordingly.

### FIELD OF THE INVENTION

The present invention relates to the field of imaging, and more particularly to the field of image capture and image viewing devices.

### BACKGROUND OF THE INVENTION

Many current image capture devices, such as digital cameras and film cameras, include circuitry for automatically setting shutter speed and apertures for proper exposure. Often these cameras choose settings assuming that they will be hand-held since the majority of users do not use camera supports. Because of this assumption, in low light conditions these automatic cameras will open up their aperture as far as possible to keep the shutter speed fast enough to allow hand holding the camera. However, by opening the aperture, the depth of field is greatly reduced. Often to allow subjects near the camera along with subjects at great distance to remain in focus, it is desirable to reduce the aperture to f/8 or less. In order to record low light subjects requiring large depth of field, the user generally resorts to using a camera support, such as a tripod or monopod, allowing the use of much slower shutter speeds to compensate for the reduced aperture. However, if the automatic camera does not know that it is being supported, it will still try to use a fast shutter speed and a large aperture.

Some current cameras and binoculars include image stabilization devices. These image-stabilized devices optically compensate for the shaking normally present when a user hand holds the device. Image stabilization in an image capture device enables the camera to use slower shutter speeds than it normally would be able to when hand held. However, these devices tend to draw substantial amounts of power, requiring frequent changes of batteries. Thus, there is a need in the art for improved image-stabilized devices.

### SUMMARY OF THE INVENTION

A support socket is built incorporating a sensor capable of detecting when the support socket is being used. When the sensor detects the use of a support utilizing the support socket, the imaging device is notified of the support allowing the device to change its mode of operation accordingly.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a cross-section view of a device including a support sensor, and a support including a bolt for attaching the device to the support.

FIG. 2 is a cross-section view of a quick release plate including a support sensor, along with a device and a support attached to the quick release plate.

FIG. 3 is a cross-section view of a quick release plate including a support sensor and a connector coupling the support sensor with a device.

FIGS. 4A and 4B are cross-section views of a quick release plate including an example mechanical implementation of the present invention.

FIG. 5 is a flowchart of a method for changing a mode of operation in an electronic device.

### DETAILED DESCRIPTION

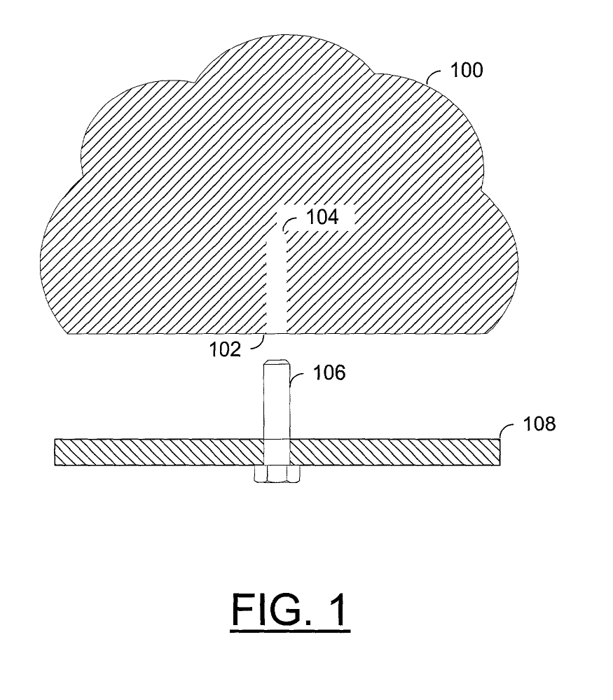

FIG. is a cross-section of a device including a support sensor, and a cross-section of a support including a bolt for attaching the device to the support. The device 100 shown in FIG. 1 may be a camera or other image capture device or any other device requiring sensing of the presence of a support. For example, image stabilized binoculars, monoculars, cameras, spotting scopes, or other devices may incorporate the present invention allowing the image stabilization to be shut down when the binoculars are used with a support, thus conserving battery life. The device 100 includes a threaded hole 102 for attachment to a support 108 such as a tripod or monopod. The device 100 is non-permanently attached to the support 108 by a bolt 106 that mates with the threaded hole 102. Also included within the threaded hole 102 is a sensor 104 capable of detecting the presence of the bolt 106 within the threaded hole 102. A camera incorporating the present invention will be able to automatically detect the use of a support and accordingly select slower shutter speeds and smaller apertures in low light situations, than would normally be usable if the camera were handheld. Since the use of a slower shutter speed allows the use of a correspondingly smaller aperture, the resulting photograph will have greater depth of field than a similar photography taken with a faster shutter speed and larger aperture (as would be necessary if the camera were hand-held.) Note that a very wide variety of supports may be used. For example, in addition to standard tripods and monopods, some camera users also use shoulder stocks, car window supports, and other devices to stabilize the camera. When the use of a support is detected, the device 100 may react to the presence of the support in ways other than changing shutter speed and aperture. For example, some single lens reflex (SLR) cameras include a mirror up feature that allows the user to swing the mirror out of the light path some time before opening the shutter. This allows the vibrations from the mirror movement to dampen before the shutter is opened, resulting in a sharper photo than would be obtained if the shutter were opened immediately after swinging up the mirror. In a camera incorporating the present invention, it is possible to have the camera detect the presence of a support, and enable mirror up mode automatically. Also note that in some instances, a user may wish to disable the support detection and mode of operation change functions so many embodiments of the present invention will include functionality enabling the user to disable changing the mode of operation.

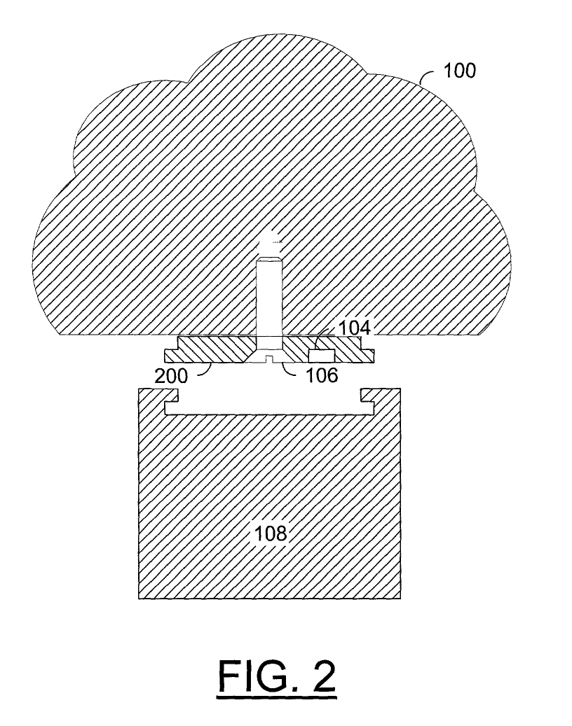

FIG. 2 is a cross-section view of a quick release plate including a support sensor, along with a device and a support attached to the quick release plate. Note that the device from FIG. 1 may be connected to a support in a variety of manners not necessarily limited to a threaded hole and a bolt. For example, many tripods include quick release features, allowing cameras (or other devices 100) to quickly be attached to and detached from the tripod 108. An example embodiment of the present invention may include the sensor 104 in the quick release plate 200 attached to the camera such that it detects the presence of the tripod or support 108 when the quick release plate 200 is attached to the tripod 108. In this example embodiment of the present invention, the quick release plate 200 is attached to the device 100 via a bolt 106 however other methods of attachments may be used. Further, the quick release plate 200 may be incorporated into the device 100 itself such that no separate quick release plate 200 is required.

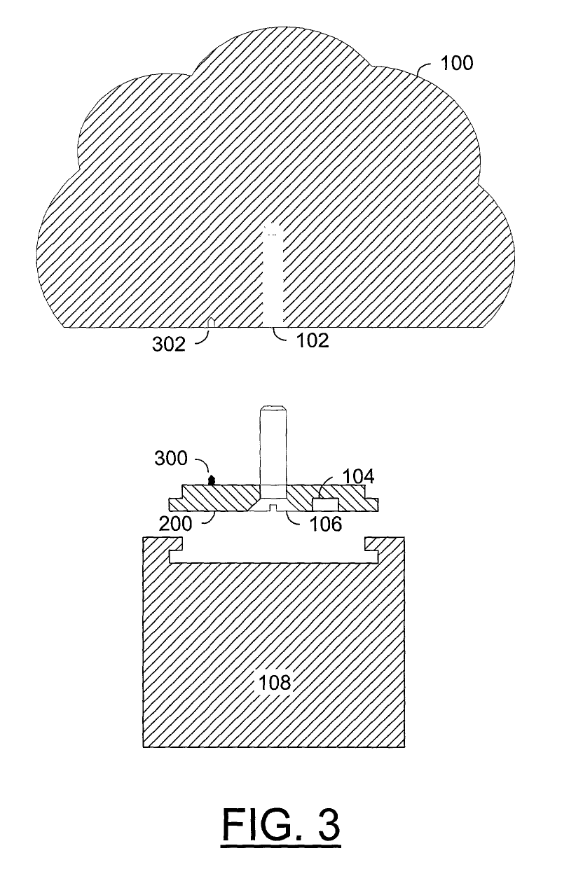

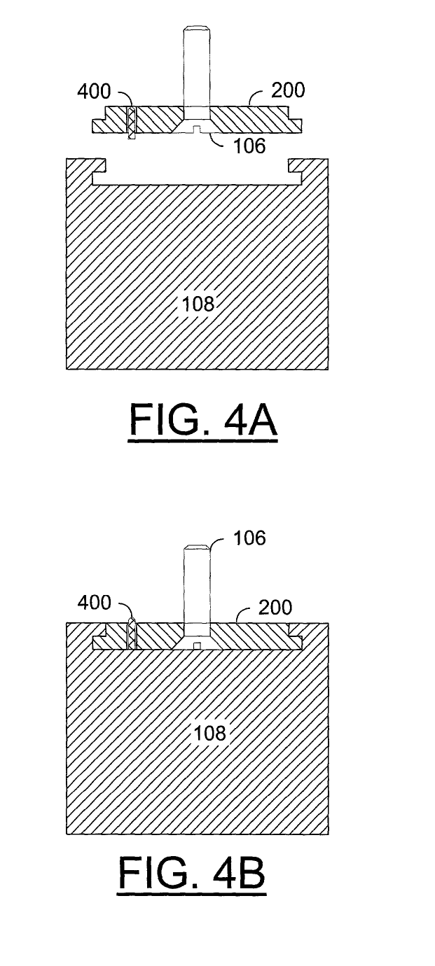

FIG. 3 is a cross-section view of a quick release plate including a support sensor and a connector coupling the support sensor with a device. This embodiment of the present invention is similar to FIG. 2, with the exception that the means for communicating that a support is present from the support sensor to the device is explicitly shown. In this example embodiment of the present invention, when the support sensor 104 detects the presence of a support 108 it signals this detection to an signal port 300 that then communicates to an device signal port 302 incorporated within the device 100. Note that these connectors may communicate the presence of the support to the device in a variety of manners. Some embodiments may electrically signal the presence of the support to the device, while others may mechanically signal the presence of the support to the device. As an example, electrical connectors may signal the presence of a support by shorting two signal lines together, or by changing a voltage on a signal line, or other equivalent methods. A mechanical connector may operate similar to a cable release in mechanically closing a contact of throwing a switch within the device. This mechanical connector may be as simple as a spring-loaded pin that moves when connected to a support, as shown in FIGS. 4A and 4B, such that the movement of the pin triggers a mode change within the device.

FIGS. 4A and 4B are cross-section views of a quick release plate including a mechanical implementation of the present invention. In FIG. 4A a quick release plate 200 and bolt 106 are shown before attachment to a support 108. The quick release plate 200 includes a spring-loaded pin 400 that is configured such that when the quick release plate 200 is not attached to a support 108 the top of the spring-loaded pin 400 is near or below the top surface of the quick release plate 200. When the quick release plate 200 is attached to a support 108 as shown in FIG. 4B, the spring-loaded pin 400 is pushed up by the support 108 such that it now extends above the surface of the quick release plate 200. If the device attached to the quick release plate 200 has the appropriate switch, socket, or other pin detection apparatus, the device is able to detect the motion of the spring-loaded pin 400 signaling the use of a support 108 and modify its mode accordingly.

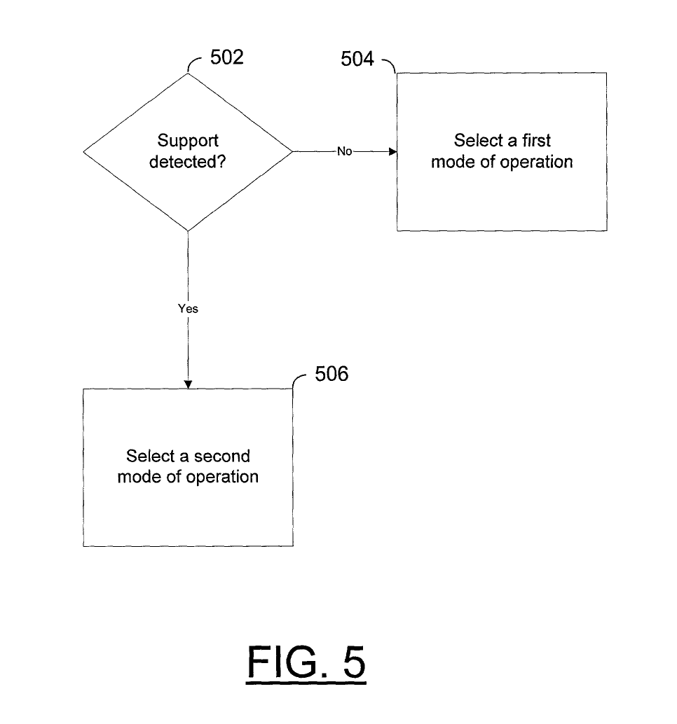

FIG. 5 is a flowchart of a method for changing a mode of operation in an electronic device. In a decision step 502, a support sensor is checked to detect the presence of a support. In a step 504, if no support is detected a first mode of operation is selected for the electronic device. In a step 506, if a support is detected a second mode of operation is selected for the electronic device. If the electronic device is a camera, many implementations of the present invention will have a first mode of operation including a first shutter speed and a first aperture, along with a second mode of operation including a second shutter speed and a second aperture. In an example embodiment of the present invention the second shutter speed is slower than the first shutter speed, and the second aperture is smaller than the first aperture. The fact that a support has been detected allows the camera to use a slower shutter speed (than would be usable without a support) and a smaller aperture increasing the depth of field of the image.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An electronic device comprising:
a support socket; and
a support sensor configured to detect a support connected to said support socket.

2. An electronic device as recited in claim 1, wherein said electronic device changes a mode of operation when a support is detected by said support sensor.

3. An electronic device as recited in claim 2, wherein said electronic device is a camera.

4. An electronic device as recited in claim 3, wherein said camera is a digital camera.

5. An electronic device as recited in claim 2, wherein said changed mode of operation includes disabling an image stabilization apparatus.

6. An electronic device as recited in claim 5, wherein said electronic device is a camera.

7. An electronic device as recited in claim 5, wherein said electronic device is a pair of image stabilized binoculars.

8. An electronic device as recited in claim 2, wherein said electronic device is configured such that a user may disable said device from changing said mode of operation.

9. An electronic device as recited in claim 2, wherein said support socket is a ¼ inch-20 threaded tripod socket.

10. An electronic device as recited in claim 2, wherein said support socket is a ⅜ inch threaded tripod socket.

11. An electronic device as recited in claim 2, wherein said support socket is a tripod quick release plate.

12. An electronic device as recited in claim 2, wherein said changed mode of operation includes changing a first shutter speed to a second shutter speed, and changing a first aperture to a second aperture.

13. An electronic device as recited in claim 12, wherein said second shutter speed is slower than said first shutter speed, and said second aperture is smaller than said first aperture.

14. A quick release plate comprising:
a support sensor configured to detect when said quick release plate is attached to a support; and
a signal port connected to said support sensor configured to non-permanently electrically connect to a device signal port, wherein an electronic device changes a mode of operation when said quick release plate is attached to said support.

15. A quick release plate as recited in claim 14, wherein said electronic device is a camera.

16. A quick release plate as recited in claim 15, wherein said camera is a digital camera.

17. An electronic device comprising:
means for attaching said electronic device to a support;
means for detecting when said device is attached to said support; and
means for changing a mode of operation of said device when said device is attached to said support.

18. An electronic device as recited in claim 17, wherein said electronic device is a camera.

19. An electronic device as recited in claim 18, wherein said camera is a digital camera.

20. An electronic device as recited in claim 17, wherein said means for changing a mode of operation includes disabling an image stabilization apparatus.

21. An electronic device as recited in claim 20, wherein said electronic device is a pair of image stabilized binoculars.

22. An electronic device as recited in claim 20, wherein said electronic device is a camera.

23. An electronic device as recited in claim 17, wherein said means for attaching is a ¼ inch-20 threaded tripod socket.

24. An electronic device as recited in claim 17, wherein said means for attaching is a ⅜ inch threaded tripod socket.

25. An electronic device as recited in claim 17, wherein said means for attaching is a tripod quick release plate.

26. An electronic device as recited in claim 17, wherein said changed mode of operation includes changing a first shutter speed to a second shutter speed, and changing a first aperture to a second aperture.

27. An electronic device as recited in claim 26, wherein said second shutter speed is slower than said first shutter speed, and said second aperture is smaller than said first aperture.

28. A quick release plate comprising:
means for attaching said plate to a support;
means for attaching an electronic device to said plate;
means for detecting when said plate is attached to said support; and
means for changing a mode of operation of said electronic device when said plate is attached to said support.

29. A quick release plate as recited in claim 28, wherein said electronic device is a camera.

30. A quick release plate as recited in claim 29, wherein said camera is a digital camera.

31. A quick release plate as recited in claim 28, wherein said means for detection comprises a spring-loaded pin.

32. A method for changing a mode of operation in an electronic device comprising the steps of:
a) detecting the presence of a support attached to a support socket;
b) selecting a first mode of operation when no support is detected; and
c) selecting a second mode of operation when a support is detected.

33. A method for changing a mode of operation in an electronic device as recited in claim 32, wherein said first mode of operation includes a first shutter speed and a first aperture, and said second mode of operation includes a second shutter speed and a second aperture.

34. A method for changing a mode of operation in an electronic device as recited in claim 33, wherein said second shutter speed is slower than said first shutter speed, and said second aperture is smaller than said first aperture.

35. A method for changing a mode of operation in an electronic device as recited in claim 32, wherein said electronic device is a camera.

36. A method for changing a mode of operation in an electronic device as recited in claim 35, wherein said camera is a digital camera.
